(19) United States
(12) Patent Application Publication
(10) Pub. No.: US 2003/0121204 A1
(43) Pub. Date: Jul. 3, 2003

(54) Hot foam compositions and methods of using the same for removing unwanted plants

(76) Inventors: Bettina Kopp-Holtwiesche, Duesseldorf (DE); Andreas Willing, Erkrath (DE); Sven Welper, Essen (DE)

Correspondence Address: COGNIS CORPORATION, 2500 RENAISSANCE BLVD., SUITE 200, GULPH MILLS, PA, 19406

(21) Appl. No.: 10/289,841

(22) Filed: Nov. 7, 2002

(30) Foreign Application Priority Data
Nov. 13, 2001 (DE) 101 55 664.0

(51) Int. Cl. A01B 79/02

(52) U.S. Cl. 47/58.1 R

(57) ABSTRACT

Processes for removing unwanted plants by application of hot foam compositions in which selected surfactant mixtures of alkyl (oligo)glycosides, optionally in combination with other auxiliaries and additives, are added to the hot foam.

### BACKGROUND OF THE INVENTION

Unwanted plant growth is normally removed by the use of chemicals which are harmful to the plant either directly or indirectly and which kill off the vegetation. Unfortunately, the chemicals used for this purpose are not only toxic to the plants, they can also be dangerous to man and to animals. In addition, many of the chemicals used are substances which are non-readily biodegradable, if at all, or which accumulate in the vegetation chain. Accordingly, the use of the chemicals in question (herbicides) is seriously restricted and requires specially qualified people. Besides chemical herbicidal techniques, there are also mechanical processes. The use of hot air and/or hot water is particularly efficient in this regard. In corresponding processes, hot air and/or hot water is/are sprayed onto the plants, the wax layer (the so-called cuticle) on the surfaces of the plants being melted and the plants dying as a result of this damage. The advantages of these processes over their chemical counterparts are obvious. There is no danger of environmental contamination and no specially trained people are required.

Besides the use of superheated steam, the use of hot foams for destroying unwanted plant growth is also known. Thus, AU-A 39335/97 describes a process for controlling vegetation in which hot water is sprayed under pressure onto the surface of the plants in order to kill off the plants. According to the disclosure of this document, both hot water itself and superheated steam or mixtures may be used. U.S. Pat. No. 5,575,111 also describes a process for destroying and controlling unwanted vegetation in which a mixture of hot water and superheated steam is mixed under pressure to form a hot foam which is applied to the plants and develops the required effect thereon by destroying the cuticle. The document in question also discloses that the use of foams in accordance with the teaching of the document is particularly advantageous because the contact time between the hot foam and the plant's surface is longer than it is where superheated steam is used. This results in the more thorough and efficient removal of weeds. To produce the foam, U.S. Pat. No. 5,575,111 teaches the use of surfactants but does not disclose any specifics as to the structure and quantity of the surfactants. DE 199 61 664 A1 discloses a hot foam process in which anionic surfactants, optionally in combination with alkyl (oligo)glycosides, are used for foaming although no particular combination of surfactants is singled out.

Although the use of foam, for example in accordance with U.S. Pat. No. 5,575,111 cited above, leads to the efficient destruction or control of unwanted plant growth, this process also has certain disadvantages in practice. In particular, the foam has to remain stable for a certain minimum time of 20 to 200 seconds, the structure of the foam, namely a fine-cell structure, also being an important factor. On the other hand, the foam should not remain stable for too long, but should collapse in a reasonable time.

### SUMMARY OF THE INVENTION

This invention relates to a process for removing unwanted plants by hot foam and to the use of certain nonionic surfactants in hot foams for removing unwanted plants.

Accordingly, the problem addressed by the present invention was to provide an improved process for destroying unwanted plant growth by hot foam. According to the invention, the disadvantages mentioned above can be overcome by the choice of certain surfactants.

Accordingly, the present invention relates to a process for removing unwanted plants by hot foam in which hot water is mixed under pressure with hot air to form a foam which is applied to the surface of the plant, characterized in that the water contains a foaming surfactant mixture selected from a) alkyl (oligo)glycosides corresponding to general formula (I) R¹O—(G)ₓ, in which R¹ is a branched or unbranched alkyl group containing 12 to 22 carbon atoms, G is a sugar unit containing 5 to 6 carbon atoms and x is an integer of 1 to 10, and b) alkyl (oligo)glycosides corresponding to general formula (II) R²O—(G)_{y}, in which R² is a branched or unbranched alkyl group containing 6 to 11 carbon atoms, G is a sugar unit containing 5 to 6 carbon atoms and y is a number of 1 to 10, other auxiliaries and additives optionally being present as additional components.

### DETAILED DESCRIPTION OF THE INVENTION

Hot foam can be produced by any of the methods known to the expert for this purpose, cf. for example U.S. Pat. No. 5,575,111 or the above-cited AU-A-39335/97. Corresponding apparatus for producing hot foams are disclosed, for example, in WO 99/02033. In general, a hot foam is produced by mixing hot water and hot air under pressure and applying the resulting foam to the plants using suitable apparatus. The temperature of the hot foam must be in a range which is sufficient to melt the layer of wax on the surface of the plants. The temperature of the hot foam in the process according to the invention is preferably in the range from 70 to 120° C., more particularly in the range from 75 to 110° C. and most particularly in the range from 80 to 110°. Depending on the particular foam generation process used, 80 to 85% by volume of hot air is mixed with 5 to 20% by volume of hot water to produce corresponding hot foams. The water or the air is heated before foam generation, preferably to temperatures of 60 to 100° C., although the air may be heated to even higher temperatures, for example of up to 150° C. The superheated steam is produced by mixing the water with compressed air, an air pressure of 1,000 to 10,000 kPa being preferred.

It is pointed out at this juncture that not only unwanted plants, but also insects, fungi, bacteria, viruses, etc. can be removed with the hot foams.

The use of the surfactant mixtures in the water for producing the superheated steam is crucial to the invention. It has been found that hot foams which, in their foaming time and in the consistency of the foam, create optimal conditions for the destruction of vegetation are obtained in accordance with the teaching of the invention.

The surfactant mixtures according to the invention contain alkyl (oligoglycosides). Alkyl and/or alkenyl oligoglycosides are known nonionic surfactants which correspond to formulae (I) and (II). They may be obtained by the relevant methods of preparative organic chemistry. The overviews presented by Bierman et al. in Starch/Stärke 45, 281 (1993), by B. Salka in Cosm. Toil. 108, 89 (1993) and by J. Kahre et al. in SÖFW-Journal No. 8, 598 (1995) are cited as representative of the extensive literature available on this subject.

The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The indices x and y in general formulae (I) and (II) indicate the degree of oligomerization (DP), i.e. the distribution of mono- and oligoglycosides, and are numbers of 1 to 10. Whereas x and y in a given compound must always be integers and, above all, may assume values of 1 to 6, the values x and y for certain alkyl oligoglycosides are analytically determined calculated quantities which are generally broken numbers. Alkyl and/or alkenyl oligoglycosides having an average degree of oligomerization x or y of 1.1 to 3.0 are preferably used. Alkyl and/or alkenyl oligoglycosides having a degree of oligomerization of less than 1.7 and, more particularly, between 1.2 and 1.4 are preferred from the applicational point of view.

It is crucial to the invention to use surfactants a) and b) in the form of a mixture. Only then is the foaming process synergistically enhanced. Surfactants a) and b) are used in a quantity ratio of 1:3 to 3:1, preferably 1:2 to 2:1 and more particularly 1:1.65.

The alkyl or alkenyl radical R¹ in component a) may also be derived from primary alcohols containing 12 to 22 and preferably 12 to 18 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof. Alkyl oligoglucosides based on hydrogenated C_{12/14} coconut oil fatty alcohol with a DP of 1 to 3 and preferably 1.1 to 1.4 are preferred.

By contrast, component b) stands for short-chain alkyl (oligo)glycosides, i.e. in formula (II), R² stands for C₆₋₁₁ alkyl groups which can be derived, for example, from hexanol, heptanol, octanol, nonanol, decanol and undecanol.

To stabilize the surfactant mixtures of a) and b), it can be of advantage to add small quantities of organic acids, preferably citric acid. The mixtures should have a pH of 5 to 7.5.

The mixtures may be used both with high active substance contents, for example 50 to 60% by weight, and in the form of low-viscosity formulations containing 10 to 30% by weight active substance. The rest is water or another suitable solvent.

The surface-active aqueous preparations which are used to produce superheated steam in the process according to the invention preferably have alkaline pH values, more particularly in the range from 8 to 12.

In order further to stabilize the foams in the process according to the invention, it has proved to be of advantage to add certain polymers—selected from the groups of polyacrylates and anionically modified polymeric heterosaccharides—to the water before the air is added or after the surfactants have been added. Within the second group, xanthan gum above all has proved to be particularly advantageous. Xanthan gum is a microbial anionic heteropolysaccharide. It is produced by Xanthomonas campestris and some other species under aerobic conditions. Xanthan gum is formed from a chain with β-1,4-linked glucose (cellulose) having side chains. The structure of the repeated units consists of glucose, mannose, glucuronic acid, acetate and pyruvate. The number of pyruvate units determines the viscosity of the xanthan gum. Other suitable polymers are starch and polymeric cellulose derivatives and also guar, methyl cellulose, carboxymethyl cellulose, hydroxyethyl cellulose, hydroxypropyl guar, alginates and/or polyacrylic acids.

The quantity of polymer which may be added in the process according to the invention is preferably in the range from 0.01 to 1% by weight (based on active substance). The superheated steams produced by the process according to the invention have fine cells and remain stable for a sufficient time. However, it is of advantage only to use the surfactant mixtures a) and b) and not to add other auxiliaries, more particularly anionic surfactants.

Another aspect of the present invention concerns the formulation of the aqueous solutions according to the invention for the generation of superheated steam. In the destruction of unwanted plants, an efficient transfer of heat takes place between foam and plant which results in the rapid and complete destruction of unwanted plant growth. The process according to the invention may be used quite generally on roads and open spaces, for example public open spaces, and in particular for the removal of unwanted roadside vegetation. However, it is also suitable for removing unwanted plants from railway tracks or aircraft runways or the like. The process according to the invention may also be used in fruit farming. One advantage of using the mixtures according to the invention is that the surfactants are readily biodegradable so that the mixtures can be placed in a low water hazard class. By virtue of the fact that the foam effect is synergistically enhanced, the amount of surfactant applied can be effectively reduced by comparison with known processes.

Accordingly, the present invention also relates to the use of the surfactant mixtures described above in hot foams for removing unwanted plants.

### EXAMPLES

In order to demonstrate the teaching according to the invention, foams were produced from aqueous solutions of various surfactants or surfactant mixtures and investigated. The concentration of the surfactants in water was always 0.5% by weight. The time for which the foam remained stable was measured in seconds. Higher values indicate better foam formation.

The results are set out in Table 1.

TABLE 1

| | Surfactant | After 100 ml | After 200 ml |
|---|---|---|---|
| C1 | C₈₋₁₀ alkyl-1,5-glycoside | 75 | 17 |
| C2 | C₁₂₋₁₆ alkyl-1,4-glucoside | 30 | 10 |
| C3 | C₁₂₋₁₇ alkanesulfonate sodium salt | 10 | 0 |
| C4 | Dodecyl benzenesulfonate sodium salt | 40 | 12 |
| A | C₈₋₁₆ alkyl-1,4-glucoside | 165 | 30 |
| | C_{12/14}:C_{8/10} quantity | | |
| | ratio = 1:1.65 | | |

It can be seen that mixture A according to the invention gives much more stable foams than the individual components (see C1 and C2) and also better results than commercially available products based on anionic surfactants.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process for destroying unwanted plant growth, said process comprising:
(a) providing a plant having a surface;
(b) contacting the surface with a hot foam composition comprising water, air and a foaming surfactant mixture, wherein the foaming surfactant mixture comprises (i) an alkyloligoglycosides corresponding to general formula (I): R¹O—(G)ₓ, wherein R¹ represents an alkyl group having from 12 to 22 carbon atoms, G represents a sugar unit having 5 to 6 carbon atoms and x is a number of from 1 to 10, and (ii) an alkyloligoglycoside corresponding to general formula (II): R²O—(G′)_{y}, wherein R² represents an alkyl group having from 6 to 11 carbon atoms, G′ represents a sugar unit having 5 to 6 carbon atoms and y is a number of from 1 to 10.

2. The process according to claim 1, wherein the alkyloligoglycosides corresponding to formula (I) and the alkyloligoglycosides corresponding to formula (II) are present in the foaming surfactant mixture in a ratio by weight of from 1:3 to 3:1.

3. The process according to claim 1, wherein the alkyloligoglycosides corresponding to formula (I) and the alkyloligoglycosides corresponding to formula (II) are present in the foaming surfactant mixture in a ratio by weight of from 1:2 to 2:1.

4. The process according to claim 1, wherein the alkyloligoglycosides corresponding to formula (I) and the alkyloligoglycosides corresponding to formula (II) are present in the foaming surfactant mixture in a ratio by weight of about 1:1.65.

5. The process according to claim 1, wherein R¹ represents a mixture of C₁₂₋₁₄ alkyl groups.

6. The process according to claim 2, wherein R¹ represents a mixture of C₁₂₋₁₄ alkyl groups.

7. The process according to claim 1, wherein R² represents a mixture of C₈₋₁₀ alkyl groups.

8. The process according to claim 2, wherein R² represents a mixture of C₈₋₁₀ alkyl groups.

9. The process according to claim 5, wherein R² represents a mixture of C₈₋₁₀ alkyl groups.

10. The process according to claim 1, wherein G and G′ each represent a glucose unit and x and y independently of one another have values of from 1.2 to 1.4.

11. The process according to claim 2, wherein G and G′ each represent a glucose unit and x and y independently of one another have values of from 1.2 to 1.4.

12. The process according to claim 9, wherein G and G′ each represent a glucose unit and x and y independently of one another have values of from 1.2 to 1.4.

13. The process according to claim 1, wherein the hot foam has a temperature of from 70 to 120° C. when contacted with the surface.

14. The process according to claim 1, wherein the foaming surfactant mixture is present in the water in an amount of from 0.1 to 25% by weight.

15. The process according to claim 2, wherein the foaming surfactant mixture is present in the water in an amount of from 0.1 to 25% by weight.

16. The process according to claim 9, wherein the foaming surfactant mixture is present in the water in an amount of from 0.1 to 25% by weight.

17. The process according to claim 12, wherein the foaming surfactant mixture is present in the water in an amount of from 0.1 to 25% by weight.

18. The process according to claim 1, wherein the hot foam composition further comprises one or more additives in an amount of from 1 to 25% by weight.

19. A process for destroying unwanted plant growth, said process comprising:
(a) providing a plant having a surface;
(b) contacting the surface with a hot foam composition having a temperature of from 70 to 120° C., comprising water, air and a foaming surfactant mixture, wherein the foaming surfactant mixture comprises (i) an alkyloligoglycosides corresponding to general formula (I): R¹O—(G)ₓ, wherein R¹ represents a mixture of C₁₂₋₁₄ alkyl groups, G represents a glucose unit and x is a number of from 1.2 to 1.4, and (ii) an alkyloligoglycoside corresponding to general formula (II): R²O—(G′)_{y}, wherein R² represents a mixture of C₈₋₁₀ alkyl groups, G′ represents a glucose unit having 5 to 6 carbon atoms and y is a number of from 1.2 to 1.4;
wherein the alkyloligoglycosides corresponding to formula (I) and the alkyloligoglycosides corresponding to formula (II) are present in the foaming surfactant mixture in a ratio by weight of from 1:2 to 2:1; and wherein the foaming surfactant mixture is present in the water in an amount of from 0.1 to 25% by weight.
